(19) United States
(12) Patent Application Publication
(10) Pub. No.: US 2004/0187110 A1
(43) Pub. Date: Sep. 23, 2004

(54) Method and apparatus for specifying properties using regular expression parameterization

(76) Inventor: Julian Boyfield, Hexham (GB)

Correspondence Address: PARK, VAUGHAN & FLEMING LLP, 508 SECOND STREET, SUITE 201, DAVIS, CA, 95616, US

(21) Appl. No.: 10/371,791

(22) Filed: Feb. 20, 2003

(51) Int. Cl. G06F 9/46

(52) U.S. Cl. 718/100

(57) ABSTRACT

One embodiment of the present invention provides a system that facilitates using regular expression parameterization to specify properties in tables in a computer system. During operation, the system receives a configuration file, wherein the configuration file contains lines that specify values for properties to be stored in rows of one or more the tables in the computer system. Next, the system processes lines in the configuration file, wherein processing a given line involves, reading a key-property list from the given line, and using property-value pairs from the key-property list to match properties in one or more rows in a table. Processing the given line also involves reading a property-value list from the given line, and using property-value pairs from the property-value list to update values for one or more properties in the matching rows. During this process, the given line can contain regular expressions that cause the system to perform parameter substitution by picking up one or more parameters while matching properties in the key property list, and then substituting the parameters into updates specified by the property-value list.

### BACKGROUND

1. Field of the Invention

The present invention relates to techniques for specifying properties related to a computer system. More specifically, the present invention relates to a method and an apparatus that uses regular expression parameterization to efficiently specify properties of devices in a computer system.

2. Related Art

Information technology organizations face a difficult challenge in managing applications and computing resources within an enterprise. The growth of networks and distributed systems has led to an increasingly complex heterogeneous computing environment, encompassing a broad spectrum of hardware, software and operating systems. Today, systems range from personal computers and workstations on users' desktops, to small and mid-sized servers in departments, all the way up to large enterprise servers and mainframes in the corporate datacenter. Moreover, computing resources may be geographically dispersed across a business campus or around the world to support global business operations.

As the complexity of computing environments has increased, system administrators have responded by adopting tools that allow administrators to monitor individual systems and hardware components from a centralized management system. However, because computing resources within an enterprise continue to evolve over time, system configuration information must be continually updated at the centralized management system.

Unfortunately, existing techniques for initially specifying and updating this type of configuration information are cumbersome. It is possible to manually specify configuration information for system components within a configuration file. However, much of this information is redundant because systems tend to include a large number of identical or similar components, such as memory modules or power supplies, and the configuration information for these identical or similar components tends to be the same. Hence, an administrator may have to input large amounts of repetitive data. Moreover, if configuration data for a specific type of component is updated, the information may have to be updated in numerous places in the configuration file. This is a time-consuming and error-prone process.

Hence, what is needed is a method and an apparatus for efficiently specifying properties of devices within a computer system without the above-described problems.

### SUMMARY

One embodiment of the present invention provides a system that facilitates using regular expression parameterization to specify properties in tables in a computer system. During operation, the system receives a configuration file, wherein the configuration file contains lines that specify values for properties to be stored in rows of one or more the tables in the computer system. Next, the system processes lines in the configuration file, wherein processing a given line involves, reading a key-property list from the given line, and using property-value pairs from the key-property list to match properties in one or more rows in a table. Processing the given line also involves reading a property-value list from the given line, and using property-value pairs from the property-value list to update values for one or more properties in the matching rows. During this process, the given line can contain regular expressions that cause the system to perform parameter substitution by picking up one or more parameters while matching properties in the key property list, and then substituting the parameters into updates specified by the property-value list.

In a variation on this embodiment, the given line in the configuration file contains a table identifier, which identifies the table to which the given line applies.

In a variation on this embodiment, prior to receiving the configuration file, the computer system initially populates the tables with information retrieved from a device tree corresponding to devices within the computer system.

In a variation on this embodiment, after all of the lines in the configuration file have been processed and corresponding updates to the tables have been made, the system accesses the tables while performing computer system management operations.

In a variation on this embodiment, the configuration file specifies values for static properties of devices in the computer system.

In a variation on this embodiment, the configuration file specifies values for properties associated with physical view images of devices in the computer system.

In a variation on this embodiment, the given line in the configuration file can additionally specify a polling interval for a dynamic property.

In a variation on this embodiment, the given line in the configuration file can additionally specify which nodes in a device tree for the computer system can be pruned from presentation to an end user.

### BRIEF DESCRIPTION OF THE FIGURES

FIG. 1 illustrates how a device tree and a configuration file are used to populate and update system tables in accordance with an embodiment of the present invention.

FIG. 2 presents a flow chart illustrating the process of populating, updating and using system tables in accordance with an embodiment of the present invention.

FIG. 3 presents a flow chart illustrating how system tables are updated from a configuration file in accordance with an embodiment of the present invention.

Table 1 presents an exemplary list of table names and corresponding property names in accordance with an embodiment of the present invention.

Table 2 presents an exemplary configuration file specifying static properties of devices in a computer system in accordance with an embodiment of the present invention.

Table 3 presents an exemplary configuration file specifying information used to display physical view images of devices in a computer system in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Tables for System Management Center

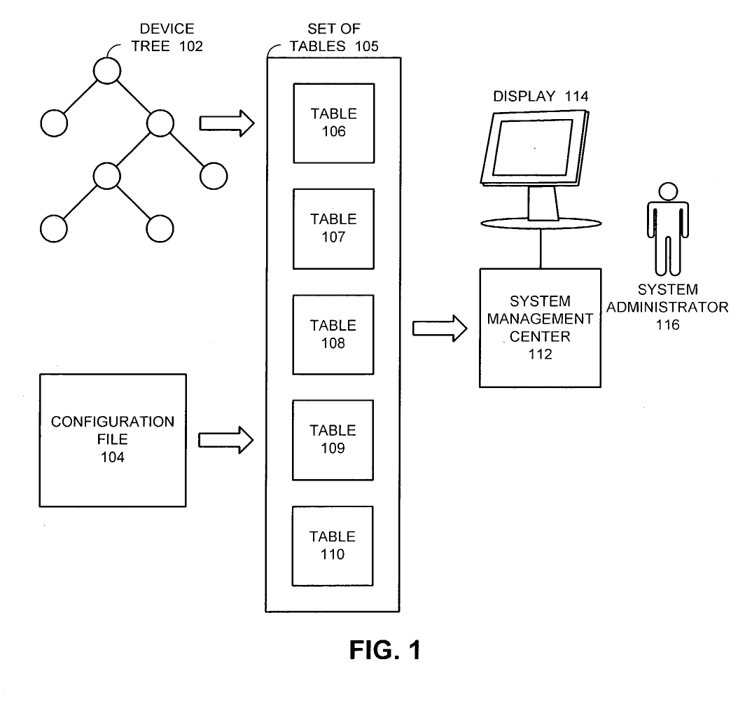

FIG. 1 illustrates how a device tree and a configuration file are used to populate and update system tables in accordance with an embodiment of the present invention. First, the system accesses device tree 102, which is a commonly used operating system data structure that contains nodes corresponding to devices in the computer system. In one embodiment of the present invention these nodes include: (1) a node name, (2) a location for each node, and (3) a status for each node. The information from device tree 102 is used to construct a set of tables 105 associated with the devices. More specifically, referring to FIG. 1, information from device tree 102 is used to construct tables 106-110. Each of these tables 106-110 contains a number of rows, wherein each row is composed of a number of column entries that are used to store values for properties.

Next, the system reads configuration file 104, and uses information from configuration file 104 to update tables 106-110 with supplemental information. In one embodiment of the present invention, configuration file 104 specifies invariant property values for associated devices, such as a description of the device or the location of the device.

In addition to static properties, configuration file 104 can also specify meta-properties of the devices. For example, in one embodiment of the present invention, configuration file 104 can specify a “polling interval” for dynamic properties associated with a given device. Configuration file 104 can also indicate whether a given device specified in device tree 102 should be pruned from presentation to system administrator 116.

Finally, system management center 112 uses the tables to provide information to a system administrator 116 through a display 114. This information enables system administrator 116 to manage the computer system.

Although the computer system associated with device tree 102 is not illustrated in FIG. 1, the computer system can generally include any type of distributed or centralized computer system that can be managed through a system management center 112. In one embodiment of the present invention, the computer system is a corporate enterprise computer system.

Process of Populating and Updating Tables

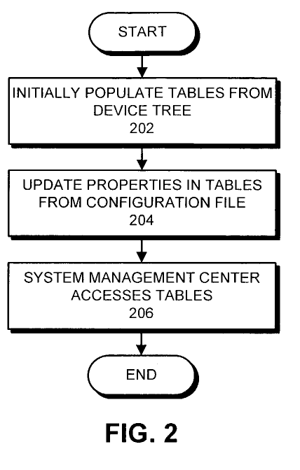

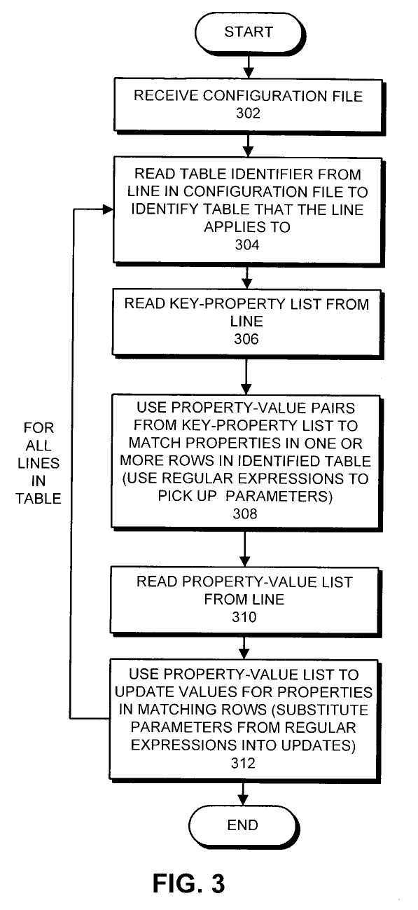

FIG. 2 presents a flow chart illustrating the process of populating, updating and using system tables in accordance with an embodiment of the present invention. The system starts by accessing a system device tree 102 and using information from device tree 102 to initially populate tables 106-110 (step 202). The system then updates property values in tables 106-110 with information from configuration file 104 (step 204). This process is described in more detail with reference to FIG. 3 below. Finally, system management center 112 accesses the tables (step 206), and uses information obtained from the tables to generate a display for system administrator 116.

Process of Updating Tables from Configuration File

FIG. 3 presents a flow chart illustrating how system tables are updated from a configuration file in accordance with an embodiment of the present invention. The system starts by receiving configuration file 104 (step 302). Next, the system reads through configuration file 104 one line at a time. For each line, the system reads a table identifier from the line to identify a table that the line applies to (step 304).

The system then reads a “key-property list” containing property-value pairs from the line (step 306). The system uses these name-value pairs to match corresponding values in one or more rows in the identified table (step 308). In doing so, if the system encounters one or more regular expressions in the line, the system can use the regular expressions to pick up one or more parameters from the matching rows in the tables.

Next, the system reads a “property-value list” containing property-value pairs from the line (step 310). The system uses the property-value pairs from the property value list to update values for corresponding properties in matching rows (step 312). In doing so, the system can substitute parameters retrieved through regular expressions into the updates (step 312).

### STATIC PROPERTIES EXAMPLE

In one embodiment of the present invention, configuration file 104 specifies static properties of devices within the computer system. In this embodiment, configuration file 104 has the following format. Blank lines and lines beginning with ‘#’ are ignored. All other lines have the following syntax:

<table>: <key property list>: <property value list>

<table>specifies the table in the browser view, and can be one of the table names that appears in Table 1 below.

<key property list> is a comma-separated list of key-value pairs which is used to match one or more table rows. Valid property names for each table are shown in Table 1 below. Each name-value pair takes the form <property name>=<value>, or simply <value> for in the case of a node name. There is also a special case property value of “_property”, which is used to specify meta values for specific properties.

TABLE 1

| Table Name | Property Names |
|---|---|
| system | NodeName, machine, platform, hostname, os_version, os_revision, |
| | obp_version |
| Fan | NodeName, Location, Description, ModelName, OperationalStatus, |
| | StatusInfo, PartNumber, Version, Manufacturer, HotSwappable, |
| | Removable |
| PowerSupply | NodeName, Location, Description, ModelName, OperationalStatus, |
| | StatusInfo, PartNumber, Version, Manufacturer, HotSwappable, |
| | Removable |
| ExpansionCard | NodeName, Location, Description, ModelName, OperationalStatus, |
| | StatusInfo, PartNumber, Version, Manufacturer, HotSwappable, |
| | Removable, BusType |
| MemoryModule | NodeName, Location, Description, ModelName, Operational Status, |
| | StatusInfo, PartNumber, Version, Manufacturer, HotSwappable, |
| | Removable, Size, BankLabel, ErrorCount |
| CPU | NodeName, Location, Description, OperationalStatus, StatusInfo, |
| | Availability, RedundancyStatus, DeviceID, ClockFrequency, family, |
| | DCache, ICache, L2Cache |
| NetworkInterface | NodeName, Location, Description, OperationalStatus, Statusinfo, |
| | Availability, RedundancyStatus, DeviceID, Speed, PermanentAddress, |
| | NetworkAddress, SymbolicName, InputErrorCount, OututErrorCount |
| Indicator | NodeName, Location, Description, OperationalStatus, StatusInfo, |
| | AlarmState, ExpectedState, Color |
| NumericTachometerTable | NodeName, Location, Description, OperationalStatus, |
| | StatusInfo, CurrentReading, NormalValues |

Note that in the <value> specification for the key property list, regular expression syntax, including parameterization, can be used. In particular, parameter substitution using \0 through \9 is allowed in the value specifications. <property value list> is another comma separated list of key-value pairs. The properties in the table row identified by the <key property list> specification will be set to the values specified. This will not however override values obtained from device tree 102, and is primarily intended to provide supplemental information, such as descriptions, a default sensor and indicator states.

Two special meta properties exist: _poll and _prune. For example, _poll=<ticks> can be used to specify a polling interval for updating a dynamic property (the property can be specified through the use of property=<property name> in the key). The value <licks> is measured in units of the polling rate of the internal property value, and is approximately one tick per second. Moreover, _prune can be used to prune any surplus table rows. Note that the pruning is performed on the logical tree, and only nodes with no children will be removed (unless their children have also been pruned).

Table 2 below includes an exemplary configuration file 104 containing static properties of devices within a computer system. Note that each entry is contained on a single line.

### PHYSICAL VIEW IMAGE EXAMPLE

In another embodiment of the present invention, configuration file 104 can be used to specify “physical view images” of computer system components. Referring to FIG. 1, these physical view images allow system administrator 116 to actually see physical images of computer system components through display 114 of system management center 112.

As with the static properties example above, lines beginning with # and blank lines are ignored. Other lines have the following syntax:

<table>:<key property list>:<pvimage data>

where <table> and <key property list> is as described for the static properties file, and <pvimage data> specifies data associated with physical view images of devices within the computer system. As with the value specifications in the static properties file, regular expression and parameter substitution may be used.

TABLE 2
Fan:Location=MB/P0/F0:Description=CPU0 fan (left - viewed from front)
Fan:Location=MB/P0/F1:Description=CPU0 fan (right - viewed from front)
Fan:Location=MB/P1/F0:Description=CPU1 fan (left - viewed from front)
Fan:Location=MB/P1/F1:Description=CPU1 fan (right - viewed from front)
Fan:Location=F0:Description=Enclosure fan (far left - viewed from front)
Fan:Location=F1:Description=Enclosure fan (second left - viewed from front)
Fan:Location=F2:Description=Enclosure fan (third left - viewed from front)
Fan:Location=F3:Description=Enclosure fan (forth right - viewed from front)
Fan:.*:OperationalStatus=OK,HotSwappable=false,Removable=false
Fan:_prop=OperationalStatus:_poll=30
PowerSupply:Location=PS0:Description=Power supply (left viewed from rear)
PowerSupply:Location=PS1:Description=Power supply (right viewed from rear)
PowerSupply:.*:HotSwappable=false,Removable=true
PowerSupply:_prop=OperationalStatus:_poll=30
ExpansionCard:pci-card:HotSwappable=false,Removable=true,BusType=PCI
MemoryModule:.*:Description=DIMM,OperationalStatus=OK,HotSwappable=false,Removable=true
MemoryModule:_prop=OperationalStatus:_poll=30
CPU:Location=MB/P0:Description=Processor (rear - viewed from front)
CPU:Location=MB/P1:Description=Processor (front - viewed from front)
CPU:.*:OperationalStatus=OK
CPU:_prop=OperationalStatus,_prop=Availability:_poll=30
NetworkInterface:.*:InputErrorCount=0,OutputErrorCount=0
NetworkInterface:_prop=InputErrorCount,_prop=OutputErrorCount:_poll=300
NetworkInterface:_prop=OperationalStatus:_poll=30
NumericTachometerTable:RS,Location=\hat{ }F(.)$0:Description=Enclosure fan \0 rotational speed
monitor
NumericTachometerTable:RS,Location=MB/P(.)$0/F(.)$1:Description=CPU\0 fan \1 rotational
speed monitor
NumericTachometerTable:.*:OperationalStatus=OK
NumericTachometerTable:_prop=CurrentReading:_poll=60
NumericTachometerTable:_prop=OperationalStatus:_poll=60

Table 3 below includes an exemplary configuration file 104 containing information associated with physical view images for devices within a computer system.

Note that the fifth line from the bottom in Table 3 refers to the “Indicator table”. In this line, a regular expression is used to pick up a power supply (PS) number as parameter 0, and an LED color as parameter 1. These parameters are substituted into a physical view location key that is used to access a corresponding physical view image to be displayed to a system administrator.

TABLE 3
system:system:chassis:null:front top rear:null:null:false
Fan:Location=\hat{ }MB/P([0-1])$0/F([0-1])$1$:cpu-fan:cpu-fan\0\1:null:null:null:false
Fan:Location=\hat{ }F([0-2])$0$:fan:fan\0:null:null:null:false
PowerSupply:Location=\hat{ }PS(.)$0$:psu\0:psu\0:null:null:null:false
MemoryModule:Location=MB/P(.)$0/B(.)$1/D(.)$2:dimm:dimm\0\1\2:null:system:null:false
CPU:Location=\hat{ }MB/P([0-1])$0$:cpu:cpu\0:null:mull:null:false
NetworkInterface:bge([0-3])$0:bge:bge\0:null:system:null:false
Indicator:LOCATE,AlarmState=off:locator-off:locator:null:system:null:false
Indicator:LOCATE:locator-on:locator:null:system:null:false
Indicator:SERVICE,Location=MB,AlarmState=off:service-off:service:null:system:null:false
Indicator:SERVICE,Location=MB:service-on:service:null:system:null:false
Indicator:ACT,Location=MB,AlarmState=off:active-off:active:null:system:null:false
Indicator:ACT,Location=MB:active-on:active:null:system:null:false
Indicator:OK2RM,Location=HDD(.)$0,AlarmState=off:led-off:hdd\0-r2r:null:system:null:false
Indicator:OK2RM,Location=HDD(.)$0,Color=(.*)$1:led-\1:hdd\0-r2r:null:system:null:false
Indicator:ACT,Location=HDD(.)$0,AlarmState=off:led-off:hdd\0-act:null:system:null:false
Indicator:ACT,Location=HDD(.)$0,Color=(.*)$1:led-\1:hdd\0-act:null:system:null:false
Indicator:SERVICE,Location=HDD(.)$0,Color=(.*)$1:led-\1:hdd\0-ser:null:system:null:false
Indicator:OK2RM,Location=PS(.)$0,AlarmState=off:led-off:psu-r2r:null:null:null:false
Indicator:OK2RM,Location=PS(.)$0,Color=(.*)$1:led-\1:psu-r2r:null:null:null:false
Indicator:ACT,Location=PS(.)$0,AlarmState=off:led-off:psu-act:null:null:null:false
Indicator:ACT,Location=PS(.)$0,Color=(.*)$1:led-\1:psu-act:null:null:null:false
Indicator:SERVlCE,Location=PS(.)$0,AlarmState=off:led-off:psu-ser:null:null:null:false
Indicator:SERVICE,Location=PS(.)$0,Color=(.*)$1:led-\1:psu-ser:null:null:null:false

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for using regular expression parameterization to specify properties in tables in a computer system, comprising:
receiving a configuration file, wherein the configuration file contains lines that specify values for properties to be stored in rows of one or more the tables in the computer system; and
processing lines in the configuration file, wherein processing a given line involves,
reading a key-property list from the given line,
using property-value pairs from the key-property list to match properties in one or more rows in a table,
reading a property-value list from the given line, and
using property-value pairs from the property-value list to update values for one or more properties in the matching rows,
wherein the given line can contain regular expressions that perform parameter substitution by picking up one or more parameters while matching properties in the key property list, and then substituting the parameters into updates specified by the property-value list.

2. The method of claim 1, wherein the given line in the configuration file contains a table identifier, which identifies the table to which the given line applies.

3. The method of claim 1, wherein prior to receiving the configuration file, the computer system initially populates the tables with information retrieved from a device tree corresponding to devices within the computer system.

4. The method of claim 1, wherein after all of the lines in the configuration file have been processed and corresponding updates to the tables have been made, the method further comprises accessing the tables while performing computer system management operations.

5. The method of claim 1, wherein the configuration file specifies values for static properties of devices in the computer system.

6. The method of claim 1, wherein the configuration file specifies values for properties associated with physical view images of devices in the computer system.

7. The method of claim 1, wherein the given line in the configuration file can additionally specify a polling interval for a dynamic property.

8. The method of claim 1, wherein the given line in the configuration file can additionally specify which nodes in a device tree for the computer system can be pruned from presentation to an end user.

9. A computer-readable storage medium storing instructions that when executed by a computer cause the computer to perform a method for using regular expression parameterization to specify properties in tables in a computer system, the method comprising:
receiving a configuration file, wherein the configuration file contains lines that specify values for properties to be stored in rows of one or more the tables in the computer system; and
processing lines in the configuration file, wherein processing a given line involves,
reading a key-property list from the given line,
using property-value pairs from the key-property list to match properties in one or more rows in a table,
reading a property-value list from the given line, and
using property-value pairs from the property-value list to update values for one or more properties in the matching rows,
wherein the given line can contain regular expressions that perform parameter substitution by picking up one or more parameters while matching properties in the key property list, and then substituting the parameters into updates specified by the property-value list.

10. The computer-readable storage medium of claim 9, wherein the given line in the configuration file contains a table identifier, which identifies the table to which the given line applies.

11. The computer-readable storage medium of claim 9, wherein prior to receiving the configuration file, the computer system initially populates the tables with information retrieved from a device tree corresponding to devices within the computer system.

12. The computer-readable storage medium of claim 9, wherein after all of the lines in the configuration file have been processed and corresponding updates to the tables have been made, the method further comprises accessing the tables while performing computer system management operations.

13. The computer-readable storage medium of claim 9, wherein the configuration file specifies values for static properties of devices in the computer system.

14. The computer-readable storage medium of claim 9, wherein the configuration file specifies values for properties associated with physical view images of devices in the computer system.

15. The computer-readable storage medium of claim 9, wherein the given line in the configuration file can additionally specify a polling interval for a dynamic property.

16. The computer-readable storage medium of claim 9, wherein the given line in the configuration file can additionally specify which nodes in a device tree for the computer system can be pruned from presentation to an end user.

17. An apparatus that uses regular expression parameterization to specify properties in tables in a computer system, comprising:
a receiving mechanism configured to receive a configuration file, wherein the configuration file contains lines that specify values for properties to be stored in rows of one or more the tables in the computer system; and
a processing mechanism configured to process lines in the configuration file, wherein while processing a given line, the processing mechanism is configured to,
read a key-property list from the given line,
use property-value pairs from the key-property list to match properties in one or more rows in a table,
read a property-value list from the given line, and to
use property-value pairs from the property-value list to update values for one or more properties in the matching rows,
wherein the given line can contain regular expressions that perform parameter substitution by picking up one or more parameters while matching properties in the key property list, and then substituting the parameters into updates specified by the property-value list.

18. The apparatus of claim 17, wherein the given line in the configuration file contains a table identifier, which identifies the table to which the given line applies.

19. The apparatus of claim 17, wherein prior to receiving the configuration file, the processing mechanism is configured to initially populate the tables with information retrieved from a device tree corresponding to devices within the computer system.

20. The apparatus of claim 17, further comprising a system management mechanism, wherein after all of the lines in the configuration file have been processed and corresponding updates to the tables have been made, the system management mechanism is configured to access the tables while performing computer system management operations.

21. The apparatus of claim 17, wherein the configuration file specifies values for static properties of devices in the computer system.

22. The apparatus of claim 17, wherein the configuration file specifies values for properties associated with physical view images of devices in the computer system.

23. The apparatus of claim 17, wherein the given line in the configuration file can additionally specify a polling interval for a dynamic property.

24. The apparatus of claim 17, wherein the given line in the configuration file can additionally specify which nodes in a device tree for the computer system can be pruned from presentation to an end user.
